(19) United States
(12) Patent Application Publication
(10) Pub. No.: US 2014/0170060 A1
(43) Pub. Date: Jun. 19, 2014

(54) ENVIRONMENTALLY RESPONSIBLE APPROACHES TO SYNTHESIS OF MULTI-FUNCTIONAL FERRATE

(71) Applicant: Bo Fan, Ames, IA (US)

(72) Inventor: Bo Fan, Ames, IA (US)

(21) Appl. No.: 14/108,539

(22) Filed: Dec. 17, 2013

Related U.S. Application Data
(60) Provisional application No. 61/738,163, filed on Dec. 17, 2012.

(51) Int. Cl. C01D 1/02

(52) U.S. Cl. CPC C01D 1/02
USPC 423/594.2

(57) ABSTRACT

People are increasingly interested in use of potassium ferrate [K₂FeO₄, or abbreviated as Fe(VI)] for clean energy production (i.e., super-iron batteries), environmental protection, and anticancer drug development. This research is focused on development of a simple method for synthesis of stable solid Fe(VI) with an one-pot environmentally responsible method. The prepared Fe(VI) was characterized with scanning electron microscopy (SEM), X-ray diffraction (XRD), and Mössbauer spectroscopy. All the characterization results indicate that Fe(VI) has its own characteristic morphology and crystal structure. Fe(VI) is very effective in removal of sulfide.

### CROSS REFERENCE TO RELATED APPLICATION

This application claims the benefit of U.S. Provisional Application No. 61/738,163 filed Dec. 17, 2012.

### BACKGROUND OF THE INVENTION

This invention is directed toward environmentally responsible approaches to synthesis of multi-functional ferrate. Fe(VI) has been considered to be an important material for the new century.^{1,2} Conventional Fe(VI) synthesis methods use iron salts [e.g., FeSO₄ or FeCl₃] as the raw materials to provide iron source and reactions proceed within aqueous phases. Three challenges exist with the conventional methods:
Generation of a large amount of liquid by products [e.g., K₂SO₄]

FeSO₄+2NaClO+4KOH→K₂FeO₄+2NaCl+K₂SO₄+2H₂O (R1)
Low stability of liquid Fe(VI)
High energy demand for converting dilute Fe(VI) to solid Fe(VI) [the desired form for much more valuable applications of Fe(VI)].
   Thus an alternative Fe(VI) synthesis method needs to be developed.

### SUMMARY OF THE INVENTION

New Fe(VI) Synthesis Method (R2 compared to R1)
The new method (R2) needs only 0.75-mole oxidizer [Ca(ClO)₂] for production of 1-mole Fe(VI), while the conventional one (R1) needs 2-mole oxidizer (NaClO)
The new method (R2) only generates 0.75-mole byproduct (CaCl₂) for production of 1-mole Fe(VI), while the conventional one (R1) generates 3-mole byproducts (NaCl+K₂SO₄)
The new process occurs in solid phase while the conventional process proceeds in aqueous phase

### New Sulfide Removal Method (R3)

The resultant elemental solid sulfur from the new sulfide removal process (R3) could be easily separated from water and used for chemical production
The resultant FeOOH from the new sulfide removal process (R3) could be separated from water and recycled for Fe(VI) production using R1, which is used for sulfide removal in next cycle.

### BRIEF DESCRIPTION OF DRAWINGS

FIG. 1 is a scanning electron microscopy (SEM) Image of Fe(VI) synthesized by the method of the present invention;

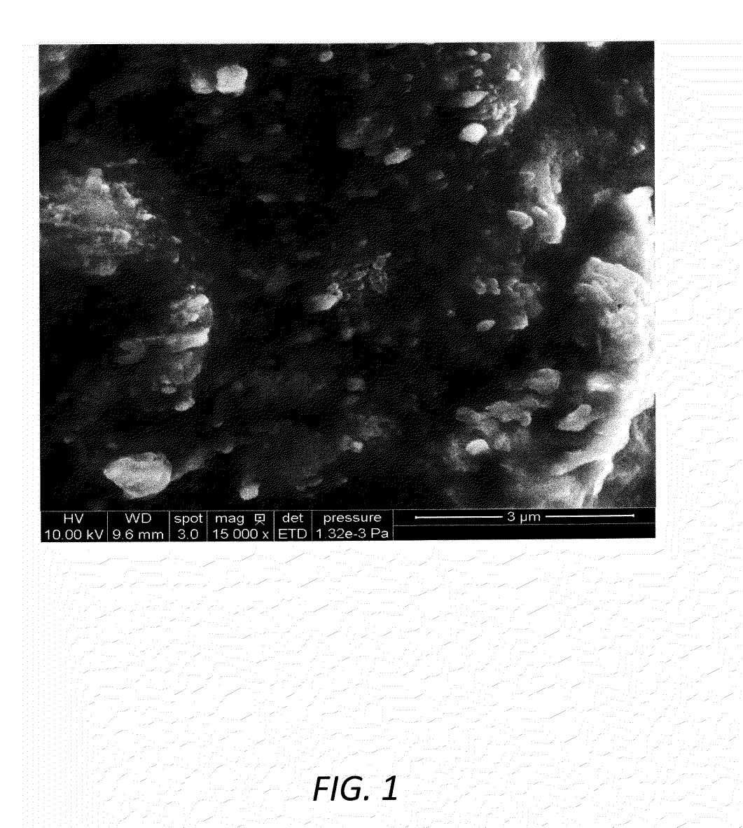

FIG. 2 is a Mössbauer spectrum of Fe(VI) synthesized by the method of the present invention.;

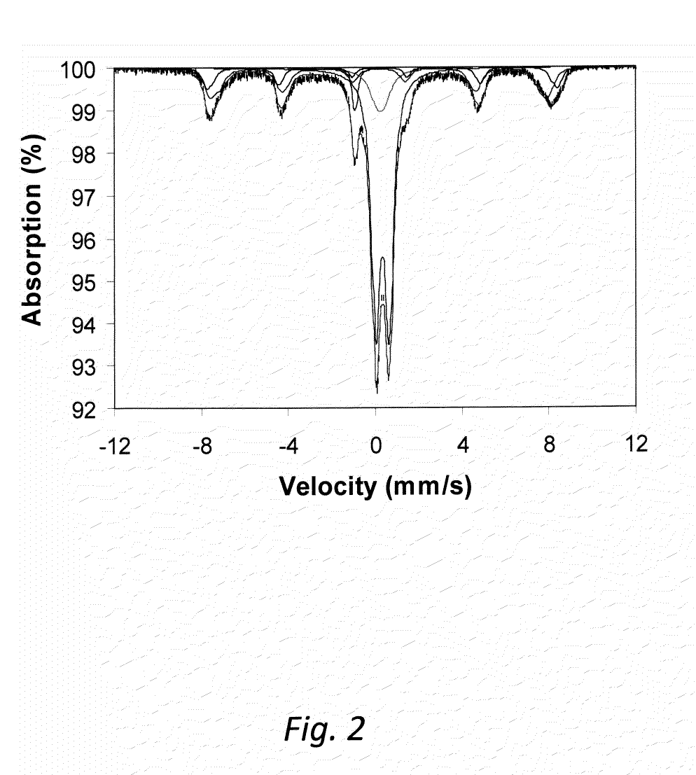

FIG. 3 is a x-ray diffraction (XRD) spectrum of FeOOH used in the synthesis of Fe(VI) by the method of the present invention;

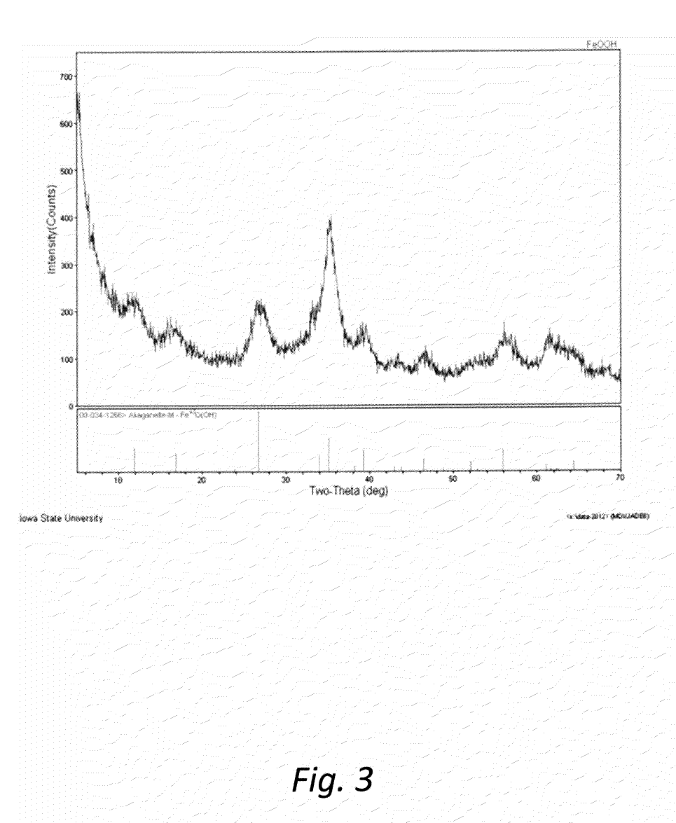

FIG. 4 is a x-ray diffraction (XRD) spectrum of Fe(VI) synthesized by the method of the present invention;

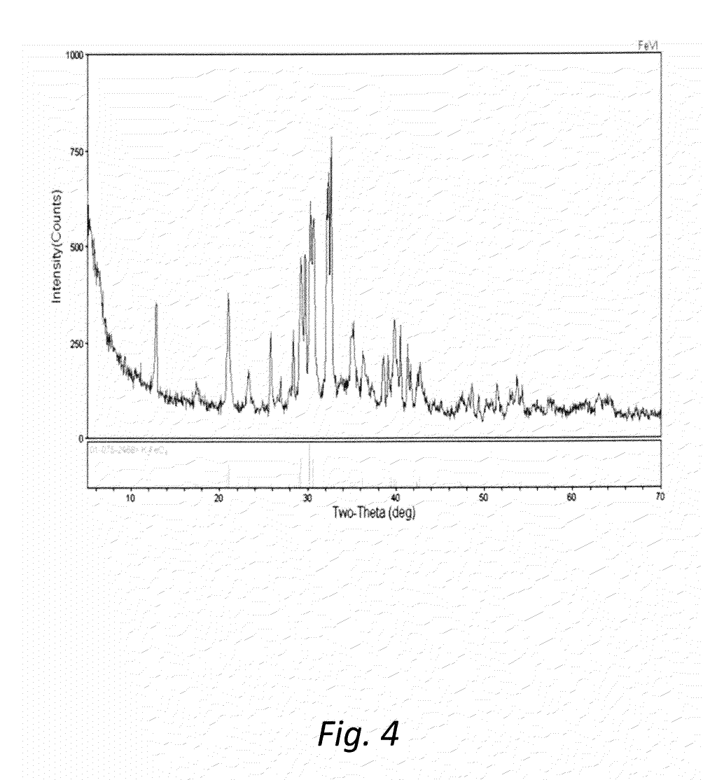

FIG. 5 is a diagram of the sulfide concentration over time upon introduction of Fe(VI) synthesized by the method of the present invention;

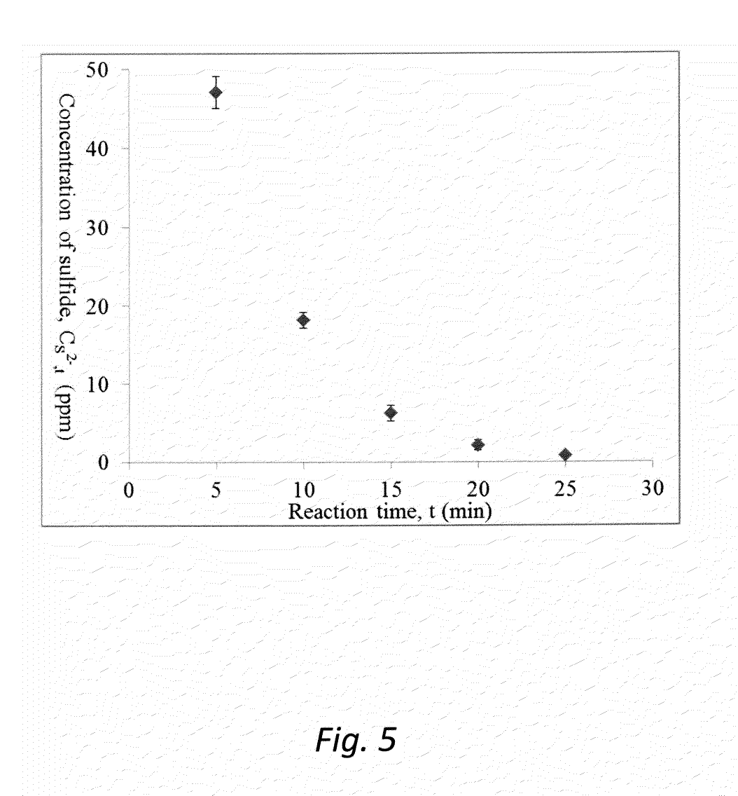

FIG. 6 is a diagram of the sulfide concentration over time upon introduction of Fe(VI) synthesized by the method of the present invention; and

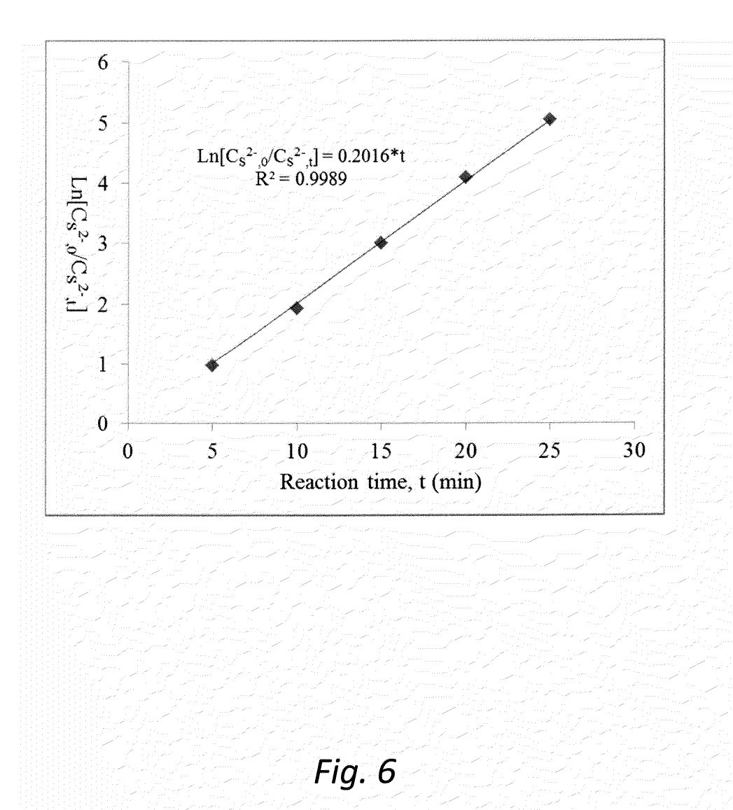

FIG. 7 is a diagram of the sulfide concentration over time upon introduction of Fe(VI) synthesized by the method of the present invention.

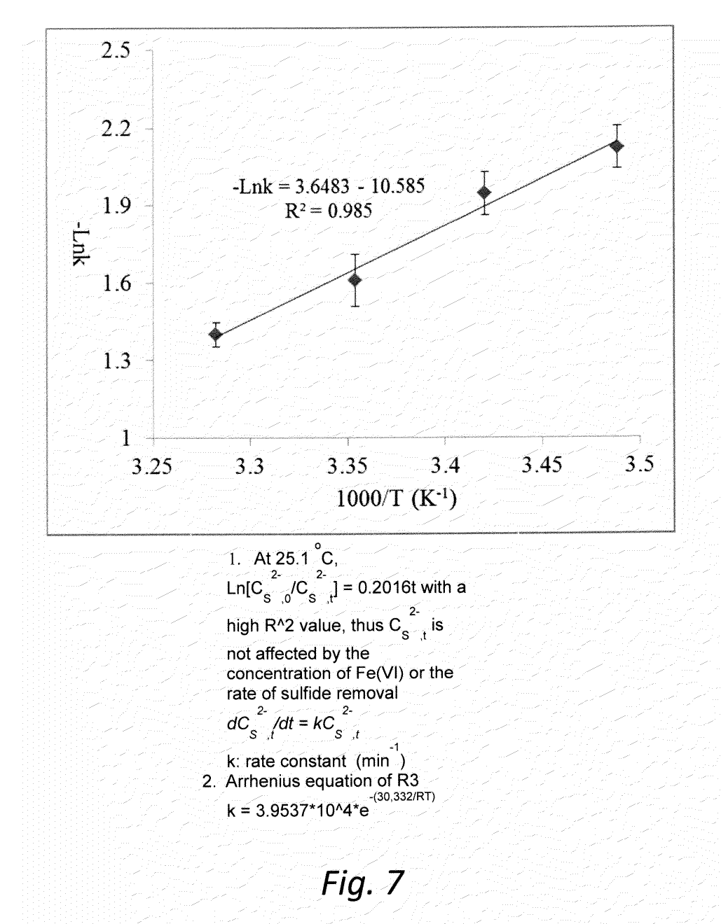

### DETAILED DESCRIPTION OF THE PREFERRED EMBODIMENT

FeOOH+0.75Ca(ClO)₂+2KOH→K₂FeO₄+0.75CaCl₂+1.5H₂O (R2)

### Synthesis Procedure

1. Impregnating FeOOH with 50% of the stoichiometrically needed amount of highly concentrated KOH solution

2. Drying the mixture in an oven at 70° C. for 3 hours

3. Mixing FeOOH—KOH with 50% amount of stoichiometrically needed ground Ca(ClO)₂

4. Stirring the mixture with a magnetic stir for 10 hours

5. Sampling the mixture for SEM, XRD and Mössbauer tests

### Characterization of Ferrate

Scanning electron microscopy (SEM, FEI Quanta-250 field-emission) for morphology
Mössbauer spectroscopy (WEB Research Co. model WT302) for measurement of Fe(VI) concentration
X-ray diffraction (XRD, Siemens D300) for structure

### Application of Ferrate—Sulfide Removal

Concentration of hydrogen sulfide (H₂S) in water: 125 ppm (mg/L)—measured with a set of sulfide test kits purchased from Hach;
H₂S removal tests: done with a 311DS Shaking Incubator (Labnet International, Inc.); water volume: 100 ml;
   Fe(VI) dosage: 13.73 mg

### RESULTS

### Kinetics of Sulfide Removal by Ferrate

Removal Reaction: 3H₂S+2FeO₄²⁻→3S↓+2FeOOH↓+4OH⁻ (R3)
Fe(VI) shows sponge morphology in its SEM image
˜22% of Fe(III) in FeOOH was converted to Fe(VI) based on the area of the peak of Fe(VI) in the above Mössbauer spectrum.
Spectra of K₂FeO₄ and FeOOH are different. Fe(VI) has its own characteristic peaks, especially at 2-θvalues of 31˜31.3°, indicating that Fe(VI) has crystal structure, but should be amorphous in general due to its broad peaks.

### Conclusion

1. The newly developed Fe(VI) synthesis and sulfide removal processes are not only effective but also environmentally responsible.
2. Fe(VI) based sulfide removal reaction is 1^{st} order with respect to (WRT) the concentration of sulfide but zero order WRT the concentration of Fe(VI)
3. The activation energy of the Fe(VI) based sulfide removal reaction is 30.332 kJ/mole

What is claimed is:

1. A method of synthesizing Ferrate, comprising the steps of:
impregnating FeOOH with 50% of the stoichiometrically needed amount of highly concentrated KOH solution;
drying the mixture in an oven at 70° C. for 3 hours;
mixing FeOOH—KOH with 50% amount of stoichiometrically needed ground Ca(ClO)₂;
stirring the mixture with a magnetic stir for 10 hours; and
sampling the mixture for SEM, XRD and Mössbauer tests
